(19) United States
(12) Patent Application Publication
(10) Pub. No.: US 2026/0312332 A1
(43) Pub. Date: Oct. 8, 2026

(54) MODULAR CONNECTOR WITH INJECTION-MOLDED SEALS

(71) Applicant: Aptiv Technologies AG, Schaffhausen (CH)

(72) Inventors: Andreas URBANIAK, Münster (DE); Uvaraj GANESAN, Tamil Nadu (IN); Rajan KUMARESH, Tamil Nadu (IN); Vijay Babu MOORTHY, Tamil Nadu (IN); Bernhard KÖLLER, Schalchen (AT)

(21) Appl. No.: 19/544,258

(22) Filed: Feb. 19, 2026

(30) Foreign Application Priority Data
Apr. 4, 2025 (EP) 25168519.4

(51) Int. Cl. H01R 13/52; H01R 13/514; H01R 43/00

(52) U.S. Cl. CPC H01R 13/5202; H01R 13/514; H01R 13/5219; H01R 43/005

(57) ABSTRACT

A modular connector includes a housing with at least two seats for receiving contact terminal modules. The housing has a first injection-molded seal directly molded onto it for sealing against a counter connector housing. Additionally, a second injection-molded seal is directly molded to the seats for sealing against an inserted contact terminal module, providing a sealed connection between the housing and the contact terminal modules, as well as between the housing and a corresponding counter connector housing.

### CROSS-REFERENCE TO RELATED APPLICATION

This application claims the benefit of and priority to European Application No. 25168519.4 filed with the European Patent Office on Apr. 4, 2025, the contents of which are incorporated by reference herein.

### TECHNICAL FIELD

The present disclosure relates to modular connectors and methods for manufacturing them. Specifically, the present disclosure involves connectors with seals for the housing and the module seats, ensuring effective sealing against counter connector housings and inserted contact terminal modules.

### BACKGROUND

In the field of modular connectors, it is common to use separate sealing elements to ensure proper sealing between connector housings and contact terminal modules. Known systems typically involve the use of gaskets, O-rings, or other discrete sealing components that must be assembled into the connector housing. These separate sealing elements are often held in place by retainers, which add complexity to the assembly process and can increase the likelihood of improper installation or seal failure. Additionally, these seals may be prone to displacement or damage during handling and use, compromising the integrity of the connection.

According to known modular connector systems, the sealing process can be cumbersome and time-consuming. The need to insert and secure separate seals into the connector housing can lead to variability in the quality of the seal and potential for human or machine error. Furthermore, the reliance on multiple components for sealing increases the number of parts that must be managed, stored, and assembled, which can complicate inventory management and increase production costs. The use of separate seals also necessitates additional design considerations to accommodate the retainers and ensure that the seals remain in place during operation.

FIG. 1 illustrates a prior art connector assembly including several components. Housing 1 forms the central structure of the connector, providing the primary enclosure for other elements. Positioned above housing 1 is a mat seal 2, which serves to provide a sealing function, ensuring that the connector remains impermeable to external elements. Housing seal 3 is located beneath housing 1, acting as an additional sealing layer to enhance the connector's integrity against environmental factors. Housing seal retainer 4 is situated at the bottom of the assembly, designed to secure housing seal 3 in place, preventing displacement or misalignment during operation. Lastly, mat seal retainer 5 is positioned at the top of the assembly, ensuring that mat seal 2 remains firmly attached to housing 1, maintaining its sealing effectiveness. This configuration illustrates the layered approach used in the prior art to achieve robust sealing and structural stability in connector assemblies.

Despite the substantial advances in the field of modular connectors, there remains a need for improved sealing solutions that simplify the assembly process, reduce the risk of seal failure, and enhance the overall reliability of the connection.

### SUMMARY

The present disclosure relates to a modular connector and methods for manufacturing the same.

In one aspect, a modular connector is provided that includes a housing having at least two module seats configured to receive contact terminal modules. The housing comprises a first injection-molded seal that is directly molded onto the housing and configured to seal the housing against a corresponding counter connector housing. The housing further comprises a second injection-molded seal that is directly molded to the at least two module seats and configured to seal the housing against contact terminal modules inserted into the module seats.

In some embodiments, the housing includes one or more channels configured to distribute a sealing material during an injection-molding process. The first injection-molded seal and the second injection-molded seal may be formed from the same sealing material or from different sealing materials. In certain embodiments, one or both of the seals are formed from a two-component sealing material, such as a two-component silicone material.

In some embodiments, the housing includes structural features configured to control the flow of sealing material during injection molding. Such features may include ribs configured to inhibit unintended spread of the sealing material and overflow openings configured to permit inspection of seal formation. In certain embodiments, the housing includes a plurality of distribution channels having different diameters, such that sealing cavities located at different distances from an injection port are filled with sealing material substantially simultaneously.

In some embodiments, all module seals are formed in a single injection process originating from a common injection port. In certain embodiments, the modular connector does not include separate sealing elements, and the module seals are protected within the housing such that a separate seal retainer is not required. The housing may be configured to include a predetermined number of module seats, for example two, three, four, five, six, or eight module seats, with one contact terminal module receivable in each module seat.

In another aspect, a modular connector system is provided that includes a pair of modular connectors according to the present disclosure, wherein the pair comprises corresponding male and female connectors configured to be mated with one another.

In a further aspect, a method for manufacturing a modular connector is provided. The method includes providing a connector housing having at least two module seats; injecting a sealing material directly onto the housing to form a housing seal configured to seal against a corresponding counter connector housing; injecting a sealing material directly into the at least two module seats to form module seals configured to seal against inserted contact terminal modules, wherein the sealing material is distributed through channels formed in the housing; and allowing the sealing material to cure such that the housing seal and the module seals are directly connected to the housing. In some embodiments, sealing material for the housing seal and sealing material for the module seals are injected through different injection ports.

### BRIEF DESCRIPTION OF THE DRAWINGS

Other features, details, and advantages of the disclosure will become more apparent from the detailed illustrative description given hereafter with respect to the drawings in which:

FIG. 1 shows an exploded view of a connector housing assembly according to the prior art.

FIG. 2A shows an end view of a modular connector with injection ports and channels for distributing sealing material for the module seats according to some embodiments.

FIG. 2B shows a side cross sectional view of the modular connector of FIG. 2A.

FIG. 3A shows an end view of the connector housing assembly of FIG. 2A rotated by 180°, indicating the injection port and channels for distributing sealing material for the housing.

FIG. 3B shows a side cross-sectional view of the connector housing assembly of FIG. 3A.

FIG. 4 shows a bottom view of a modular connector housing with multiple seats for receiving contact terminal modules according to some embodiments.

FIGS. 5A and 5B show isometric views of a female modular connector housing with injection ports and seals according to some embodiments.

FIGS. 6A and 6B show isometric views of a male modular connector housing, corresponding to the female housing of FIGS. 5A and 5B, with module seats and injection ports for seals according to some embodiments.

FIGS. 7A to 7F show top views of various modular connectors with different numbers of module seat and injection ports according to some embodiments.

FIGS. 7G to 7L show isometric views of the various modular connectors with different numbers of module seat and injection ports according to some embodiments.

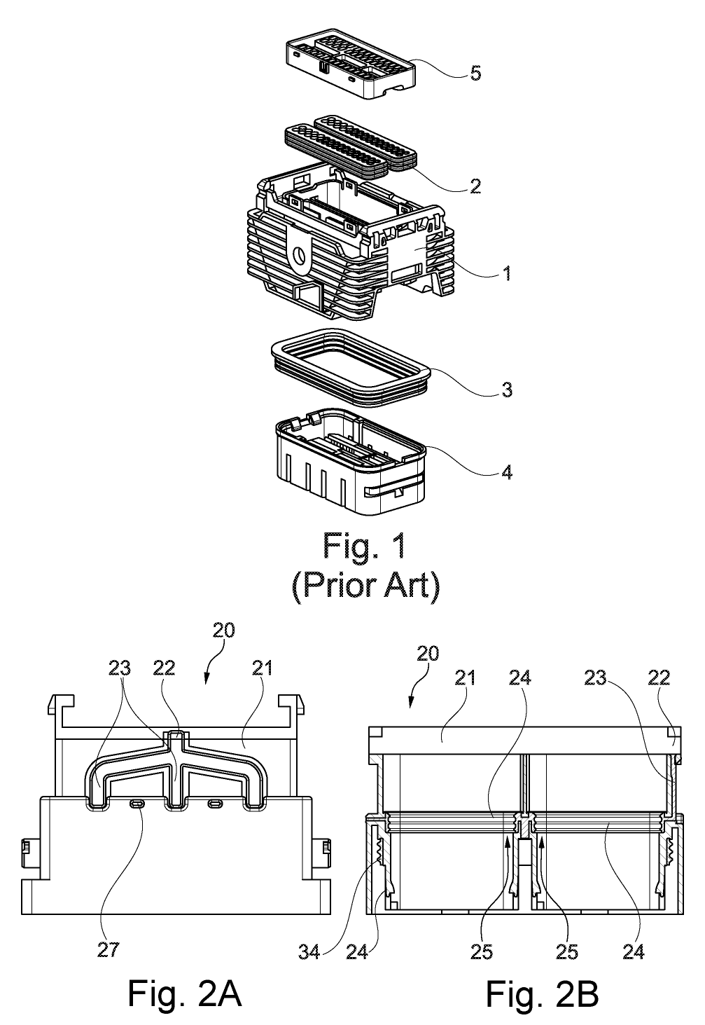

### DETAILED DESCRIPTION

FIGS. 2A and 2B show a modular connector 20 according to an embodiment including a housing 21 with various integrated components for sealing and receiving contact terminal modules. In FIG. 2A, the housing 21 is depicted with an injection port 22 for the module seal. The channels 23 distribute the sealing material from the injection port 22 to the designated areas within the housing. An overflow opening 27 is visible, allowing inspection of the completeness and quality of the sealing material injection process. A housing seal 34 is directly molded onto the housing 21, ensuring a secure seal against a corresponding counter connector housing.

FIG. 2B illustrates a cross-sectional view of the modular connector 20, highlighting the seats 25 for receiving contact terminal modules. The module seals 24 are directly molded to the seats 25, providing a seal against any inserted contact terminal modules. The channels 23 facilitate the distribution of the sealing material to the seats 25, ensuring consistent sealing throughout the housing.

The injection port 22 is strategically positioned to enable efficient injection of the sealing material into the channels 23. The channels 23 are designed to distribute the sealing material evenly to the module seats 25, ensuring that the module seals 24 are formed uniformly.

The modular connector 20 is designed to accommodate multiple contact terminal modules, with each module seat 25 receiving a module and being sealed by the module seal 24. The housing seal 34 provides an additional layer of sealing, ensuring that the connector housing 21 is securely sealed against a corresponding counter connector housing.

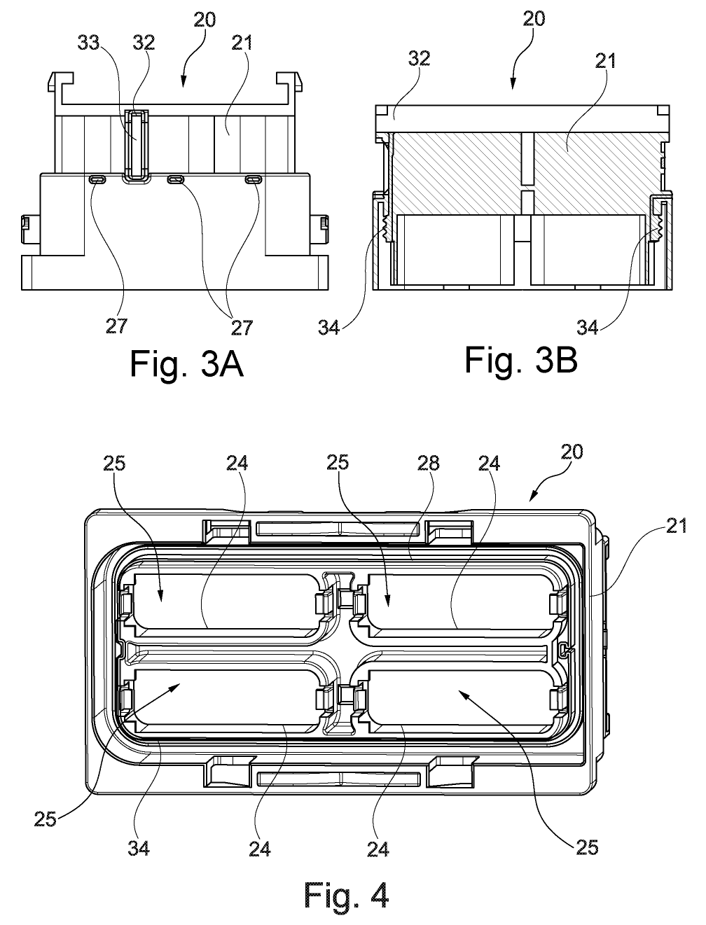

FIG. 3A shows the same modular connector 20 from the opposite side as FIG. 2A (i.e., rotate by 180°). The housing 21 includes an injection port 32 for the housing seal 34. The housing seal 34 is directly molded onto the housing 21, providing a seal against a corresponding counter connector housing. The injection port 32 is connected to channels 33 that distribute the sealing material throughout the housing 21. Overflow openings 27 are included in the housing 21 to allow inspection of the completeness and quality of the sealing material injection.

FIG. 3B illustrates a cross-sectional view of the modular connector 20, rotate by 90° in relation to the view of FIG. 3A. In FIG. 3B, the cross-sectional view highlights the internal distribution of the sealing material and the formation of the housing seal 34.

FIG. 4 shows the modular connector 20 as seen from the bottom. One can see multiple (four) seats 25 designed to accommodate a contact terminal module. The housing 21 has a rectangular structure, providing a robust framework for the modular connector 20. The arrangement of these seats is symmetrical, optimizing the spatial distribution within the housing 21.

A significant feature is the presence of injection-molded seals 24 and 34. Seal 24 is directly molded onto each of the module seats 25, ensuring a tight seal between the housing 21 and any inserted contact terminal module. This seal is advantageous for maintaining the integrity of the connection and preventing any ingress of contaminants or moisture that could compromise the electrical performance of the connector.

Additionally, the housing seal 34 serves the purpose of sealing the housing 21 against a corresponding counter connector housing, thereby ensuring a secure and reliable connection between the modular connector 20 and its counterpart. The housing seal 34 is strategically positioned along the outer edge of the housing 21, providing a continuous barrier that enhances the connector's resistance to environmental factors.

FIG. 4 also highlights the presence of ribs 28 within the housing 21. These ribs are designed to prevent silicone spill during the injection molding process, ensuring that the sealing material is precisely distributed and contained within the designated areas. The ribs 28 follow the flow and arrangement of the housing seal 34 and form a barrier for the sealing material.

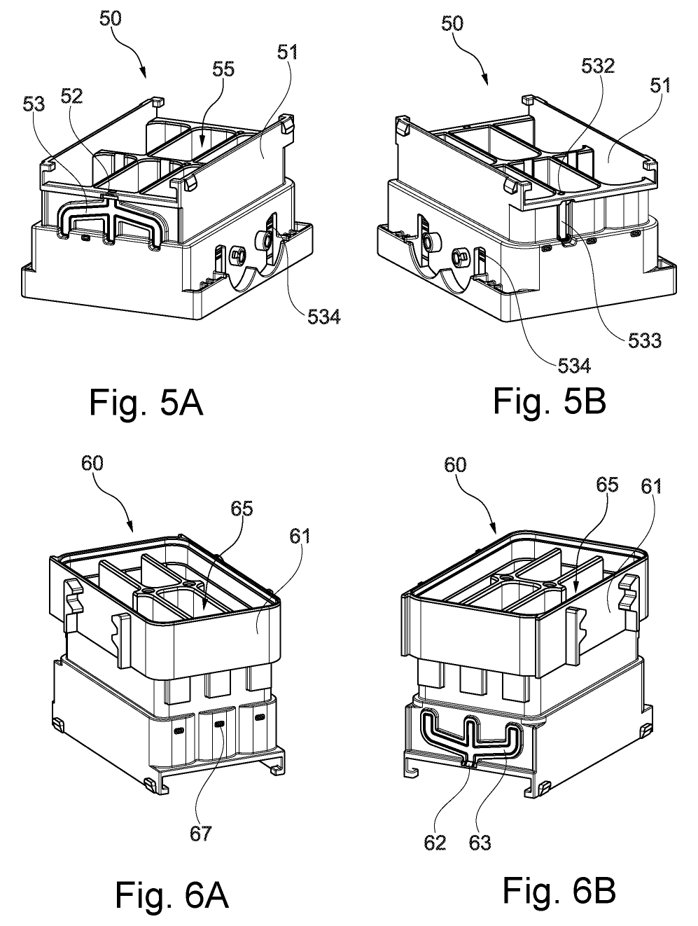

FIGS. 5A and 5B illustrate two views of a modular connector 50 from different perspectives (rotated by 180°), specifically a female modular connector housing 51. The housing 51 is designed to accommodate contact terminal modules within its (six) module seats 55. The housing 51 features an injection port 52 for the module seal and another injection port 532 for the housing seal. The module seal channels 53 are visible, distributing the sealing material from the injection port 52 to the module seats 55. The housing seal channels 533 are also shown, distributing the sealing material from the injection port 532 to the housing seal 534. The housing seal 534 is directly molded onto the connector housing 51, providing a seal against a corresponding counter connector housing. The module seats 55 are designed to receive contact terminal modules, and the module seals are directly molded to these seats to ensure a secure seal against the inserted contact terminal modules. The modular connector 50 does not include separate sealing elements, as all seals are directly molded onto the housing 51.

FIGS. 6A and 6B illustrate an embodiment of a modular connector 60, specifically focusing on the male connector housing 61, which is shown from two perspectives (rotated by 180°). The connector housing 61 is the counterpart to the female housing 51, such that both housings together form a modular connector system. The housing 61 likewise includes six module seats 65, which are designed to accommodate contact terminal modules. In mated condition of male housing 61 and female housing 51, the respective module seats are aligned to allow electrical connection between the contact terminals assigned to the respective modules arranged in the seats 55, 65.

FIG. 6B highlights the injection port 62, which is a critical component in the manufacturing process of the connector. This port is used for the injection of sealing material for the sealing of the module seats. The sealing process is further supported by distribution channels 63, which are visible in the figure. These channels facilitate the even distribution of the sealing material throughout the housing, ensuring a uniform seal that enhances the connector's reliability and performance.

The connector housing 61 is also equipped with overflow openings 67, which serve a dual purpose. Firstly, these openings allow for the inspection of the completeness and quality of the sealing material injection, providing a visual confirmation that the seal has been properly formed. Secondly, they act as a safety feature, preventing excess sealing material from accumulating within the housing, which could potentially compromise the integrity of the seal.

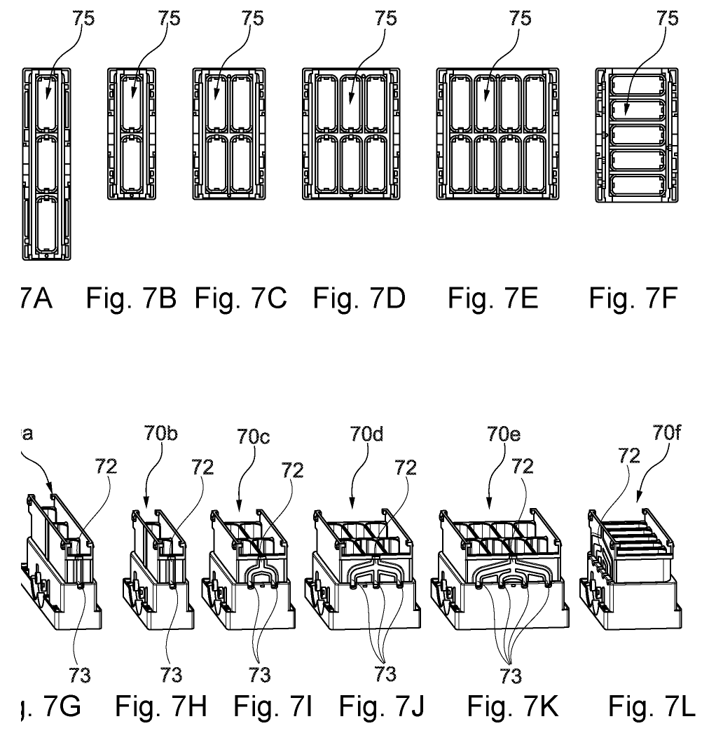

FIGS. 7A-7L illustrate various embodiments of modular connectors with different configurations of module seats. FIGS. 7A-7L showcases six distinct modular connectors, each designated by reference numerals 70a, 70b, 70c, 70d, 70e, and 70f. These connectors are differentiated by the number of module seats 75 they possess, which range from two to eight seats.

FIGS. 7A-7F display top views of the connectors, highlighting the module seats 75. Each connector housing is designed to accommodate a specific number of contact terminal modules. For instance, connector 70a features three module seats 75, while connector 70b has two module seats 75. Connector 70c includes four module seats 75 in a rectangular configuration, connector 70d has six module seats 75, connector 70e includes eight module seats 75, and connector 70f is equipped with five module seats 75 arranged in a linear fashion.

FIGS. 7G-7L presents isometric side views of the connectors, emphasizing the injection ports 72 and the distribution channels 73. The injection ports 72 serve as entry points for the sealing material, which is then distributed through the channels 73 to form the seals around the module seats 75.

Each connector housing is equipped with channels 73 that vary in diameter and length, ensuring that the outer sealing cavities are filled with the sealant material at approximately the same time as the inner cavities, which are closer to the injection port 72.

The modular connectors depicted in FIGS. 7A-7L are designed to be versatile and adaptable, accommodating different configurations of contact terminal modules. The seals created by the injection molding process are directly molded onto the connector housing and the module seats, providing a robust and reliable sealing solution, independent from the number of module seats incorporated in the respective housing. This eliminates the need for separate sealing elements and seal retainers, simplifying the assembly and maintenance of the connectors.

While the invention has been described with reference to an exemplary embodiment(s), it may be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It may also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It may also be understood that the term “and/or” as used herein refers to and encompasses any and all possible combinations of one or more of the associated listed items. It may be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### REFERENCE SIGN LIST

1 prior art connector housing
2 mat seal
3 housing seal
4 housing seal retainer
5 mat seal retainer
20 modular connector
50 female modular connector
21, 51, 61 housing
22, 52, 62, 72 injection port for module seal
23, 53, 63, 73 channels (for module seal)
24 module seals
25, 55, 65, 75 seats for receiving contact terminal modules
26 latching arms
27 overflow opening
28 rib to stop silicone spill
32, 532 injection port for housing seal
33, 533 channels (for housing seal)
34, 534 housing seal
60 male modular connector
70a modular connector with three module seats
70b modular connector with two module seats
70c modular connector with four module seats
70d modular connector with six module seats
70e modular connector with eight module seats
70f modular connector with five module seats

1. A modular connector, comprising:
a housing having at least two seats for receiving contact terminal modules, wherein the housing comprises a first injection-molded seal and wherein the first injection-molded seal is directly molded onto the connector housing, for sealing the housing against a corresponding counter connector housing; and
a second injection-molded seal, wherein the second injection-molded seal is directly molded to the at least two seats, for sealing the housing against an inserted contact terminal module.

2. The modular connector of claim 1, wherein the housing comprises channels for distributing a sealing material.

3. The modular connector of claim 1, wherein the housing seal is made from a different material than the module seal.

4. The modular connector of claim 1, wherein the seals are made from a two-component sealing material.

5. The modular connector of claim 4, wherein the two-component sealing material is a two-component silicone material.

6. The modular connector of claim 4, wherein the housing comprises at least two distribution channels, wherein the at least two channels have varying diameters so that outer sealing cavities are filled with the two-component sealing material at approximately the same time as inner cavities that are closer to an injection port.

7. The modular connector of claim 1, wherein the connector housing comprises ribs designed to prevent silicone spill during an injection molding process.

8. The modular connector of claim 1, wherein the housing includes overflow openings to allow inspection of completeness and quality of a sealing material injection.

9. The modular connector of claim 1, wherein all module seals are created by a single injection process starting from the same injection port.

10. The modular connector of claim 1, wherein the modular connector does not comprise separate sealing elements.

11. The modular connector of claim 1, wherein the module seals are protected inside the housing, thereby eliminating a need for a separate seal retainer.

12. The modular connector of claim 1, wherein the housing has exactly two, three, four, five, six, or eight module seats.

13. The modular connector of claim 1, wherein one contact terminal module is mounted in each module seat of the connector housing.

14. A modular connector system, comprising two modular connectors according to claim 1, wherein the two modular connectors are corresponding male and female connectors adapted to be mounted to each other.

15. A method for manufacturing a modular connector, comprising:
providing a connector housing with at least two module seats;
injecting a sealing material directly onto the connector housing, for sealing the housing against a corresponding counter connector housing;
injecting a sealing material directly into the at least two seats, for sealing the housing against an inserted contact terminal module and distributing the sealing material through channels in the housing; and
allowing the sealing material to cure, thereby forming a molded seal that is directly connected to the housing.

16. The method of claim 15, wherein the sealing material for the housing seal is injected at a different injection port than the module seal.
